(19) United States
(12) Patent Application Publication
(10) Pub. No.: US 2021/0146700 A1
(43) Pub. Date: May 20, 2021

(54) MEDIA IDENTIFICATION

(71) Applicant: HEWLETT-PACKARD DEVELOPMENT COMPANY, L.P., Spring, TX (US)

(72) Inventors: Carles Flotats Villagrasa, Sant Cugat del Valles (ES); Francesc Ros Cerro, Sant Cugat del Valles (ES); Douglas Knight, San Diego, CA (US); Alexander David McDowell, Sant Cugat del Valles (ES); Benjamin Jules Millner, Sant Cugat del Valles (ES); Alan Jacques, San Diego, CA (US)

(73) Assignee: HEWLETT-PACKARD DEVELOPMENT COMPANY, L.P., Spring, TX (US)

(21) Appl. No.: 17/047,298

(22) PCT Filed: May 8, 2018
(86) PCT No.: PCT/US2018/031504

§ 371 Date: Oct. 13, 2020

(51) Int. Cl. B41J 11/00; B41J 15/04

(52) U.S. Cl. CPC B41J 11/009; B41J 15/042

(57) ABSTRACT

There is provided a print apparatus and a media roll for the print apparatus, comprising a media identifier located on an end of a core section of the media roll. A type of media loaded into the print apparatus is determined by sensing the media identifier on the media roll using a non-contact sensor to scan the end of the core section.

### BACKGROUND

The present disclosure relates to identifying a type of media in a rendering apparatus for the purpose of selecting pre-determined print settings for the relevant media. In existing systems, the detection of the type of media may be achieved using sensors able to read markings on the media itself. For example, a top-of-form sensor can read indicia on the media. A length of media that is remaining may also be determined using indicia encoding the number of remaining sheets. However, marking the media leads to media wastage. In other known systems, the core of a media roll may be marked and a sensor may be provided on a spindle of the rendering apparatus to scan the markings on the inside of the core of the media roll. For example, the sensor may read an annular barcode inside the core. However, a sensor on the spindle with rotating electrical contacts is expensive.

### BRIEF DESCRIPTION OF THE DRAWINGS

Various features and advantages of certain examples will be apparent from the detailed description which follows, taken in conjunction with the accompanying drawings, which together illustrate, by way of example only, a number of features, and wherein:

FIG. 1 shows a schematic of a media roll comprising indicia on the end of the core of the media roll according to an example:

FIG. 2A shows a schematic of a media identifier provided on the end of a core section according to an example;

FIG. 2B shows a schematic of the scanning path of a sensor scanning a media identifier on the end of a core section according to an example;

FIG. 3A shows a schematic of a media input portion 300 or structure for receiving a media roll according to an example;

FIG. 3B shows a schematic of the first hub according to an example;

FIG. 3C shows an expanded section of the first hub according to an example;

FIGS. 4A and 4B show a schematic of a media roll loaded onto the media input portion according to an example;

FIGS. 5A-C show a method of determining a type of media in a print apparatus according to an example; and

FIG. 6 shows a processor comprising instructions for determining a type of media according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

The present disclosure relates to identifying a type of media in a rendering apparatus for the purpose of selecting pre-determined print settings for the relevant media. Print settings for different types of media may be stored in a memory of the rendering apparatus or external database accessible by the rendering apparatus. The print settings for different media types may be stored in a look-up-table. Print settings may comprise vacuum, available print modes, maximum drying temperature, quantity of rendering fluid and/or color profiles.

A user may load a media roll into a rendering apparatus. Pre-determined print settings suitable for the media can be selected according to the type of media which is loaded. For example, the user can either select the type of media loaded via an onscreen panel or the rendering apparatus can detect the type of media automatically. Media identification may be performed using a sensor or code reader that scans indicia on the media roll. For a media to be recognised by the rendering apparatus, a core section of the media roll can be marked or provided with indicia at the moment of manufacturing. According to an example, the media identifier may comprise indicia or markings from stamping, printing or notching of the end of the core section of the media roll, or via inserts of a digital labelling system. For example, the media identifier may be provided using mechanical notching of the core, stamping, or via a digital labelling system where the indicia or code may contain a serial number such as using RFID tags. The media identifier may comprise grooves, notches, slots, embossments or other physical features that may be provided via mechanical tooling, heated elements or laser engraved markings. According to an example, the media identifier comprises a bar code. When the media identifier is printed onto the core of the media roll, a combination of two or more print fluids may be used to increase the contrast of the code and improve its readability.

According to an example, the sensor is a non-contact sensor.

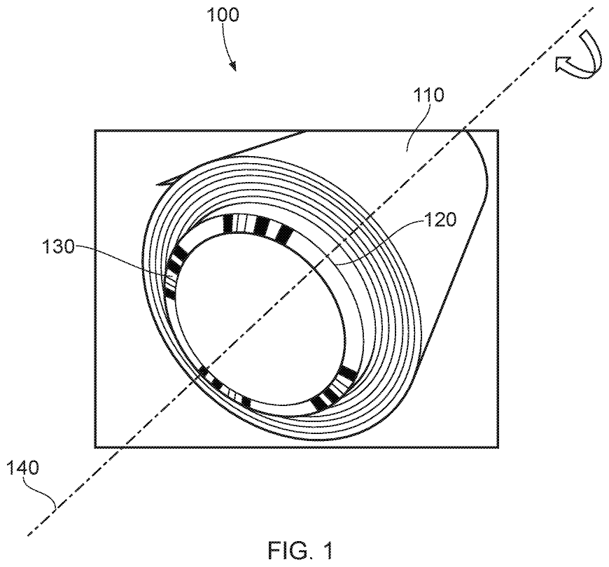

FIG. 1 shows a schematic of a media roll comprising indicia on the end of the core of the media roll. The media roll 100 comprises a media section 110 and a core section 120. The media section surrounds the core section. For example, the media section may comprise paper. The core section may comprise cardboard material. The core section is provided with a media identifier 130. The media identifier is located on an end of the core section. The end of the core section comprises the distal ends of an elongate media roll, i.e. the end is considered to be the lateral sides of the elongate portion and not the inside of the core which may be adjacent a spindle when loaded into a rendering apparatus. According to an example, the media identifier is not provided on the media nor on the media section but is only provided on the core section of the media roll. The media identifier can be disposed annularly about the end of the core section. For example, the media identifier may be disposed annularly about an axis of rotation 140 of an end of the core section or media roll. The media roll can rotate around the axis of rotation to dispense media from the media section, for example during rendering of an image on the media. As such, the sensor is configured to scan the media identifier or code on the sides of the media roll as it turns or rotates.

The media identifier may be provided on one or both ends of the core section of the media roll. When a media identifier is provided on both ends of the core section, the identifier or indicia may be identical or different. For example, some media can be loaded into a rendering apparatus with the media printable-side-in and printable-side-out, in which example both ends of the core section can be marked. According to an example, an image may be rendered on a correct side of the media (with the other side of the media being an incorrect side). The marks on the core can be used to advise a user if he or she has loaded the media in an incorrect orientation. For example, the identifier on one side of the core may contain a serial number and the identifier on the other side of the core may contain a code indicating an incorrect media loading to the user.

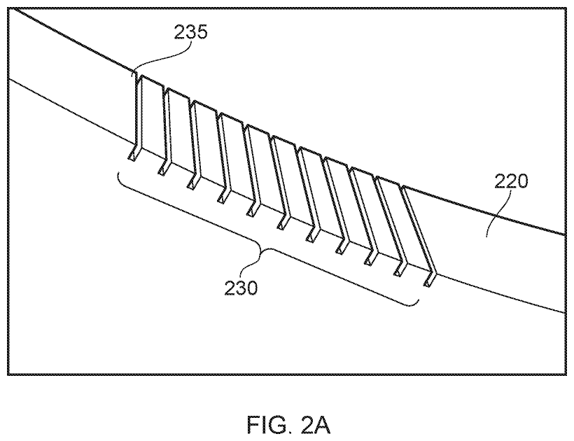

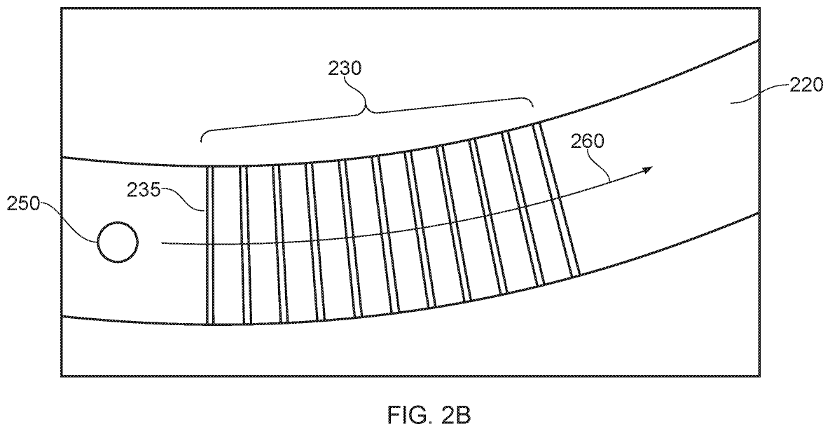

FIG. 2A shows a schematic of a media identifier provided on the end of a core section. A media identifier 230 may comprise physical discontinuities 235 in a surface of the core section 220 of the media roll. The physical discontinuities may be provided via laser engravings of the end of the core section. A series of discontinuities or grooves or slots may have a width or spacing between them to form a code to be scanned by a sensor. The media identifier or detection marks may be engraved, notched, scored, or cut into the end of the core section. This provides a media identifier that is permanent and durable. According to an example, the media identifier comprises a series of lines or engravings arranged in a pattern of marks and non-marks to be interpreted as a code which may be a barcode or other means of deciphering the series of marks.

FIG. 2B shows a schematic of the scanning path of a sensor scanning a media identifier on the end of a core section. For example, the sensor may project an LED beam spot 250 onto the media identifier 230. As the media roll rotates about the axis of revolution 140 during rendering of an image on the media, the beam spot sweeps out a detection path 260 to scan the series of discontinuities 235 and read the code. If the code or barcode may comprise a part number and/or a serial number, such that the rendering apparatus can track the length of media remaining on the media roll. For example, if the code in the core section contains a serial number and a product number, the rendering apparatus can keep accurate track of the remaining media and warn the user if the requested job is too long for the media available.

According to an example, a sensor is configured to scan an axis of rotation of the media roll. The positioning of the sensor is such that the sensor is able to scan the media identifier on the core section. The location of the media identifier on the end of the core section of the media roll allows precise positioning of the code relative to the sensor when the media roll is loaded into the rendering apparatus.

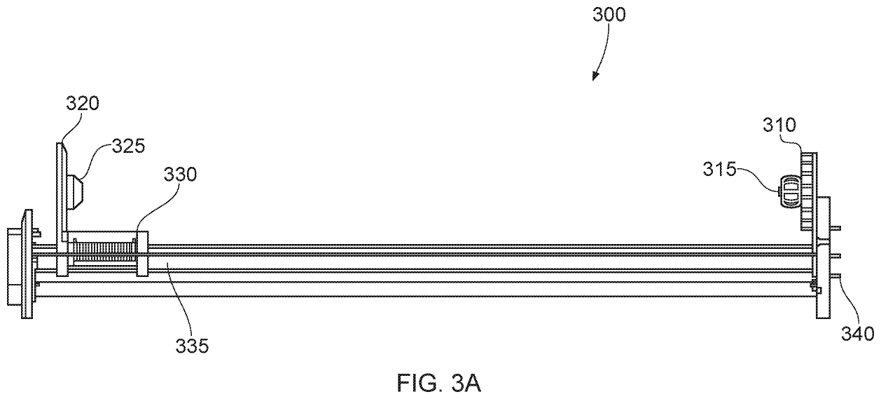

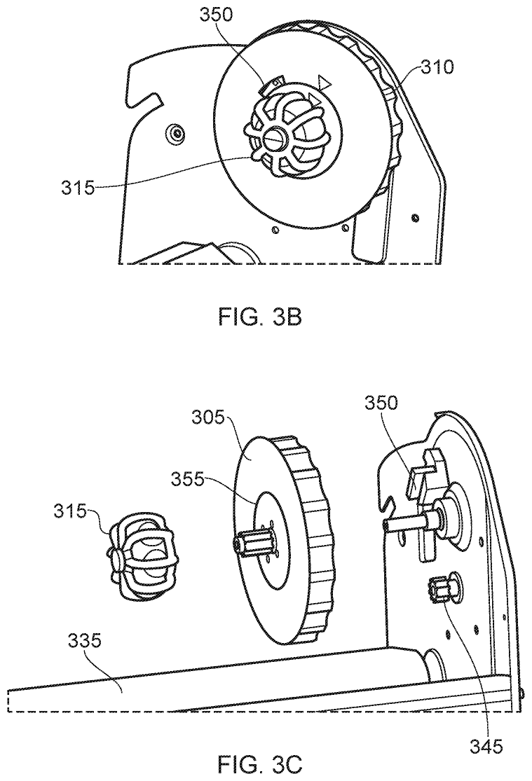

FIG. 3A shows a schematic of a media input portion 300 or structure for receiving a media roll. According to an example, a sensor such as a photo-detector, may be mounted or provided on a first hub 310. The hub may form part of the media input portion or the rendering apparatus. The configuration of the sensor and hub is such that the sensor is able to scan the core section or end of the media roll, i.e. the sensor scans the axis of revolution of the media roll and core section. The sensor is configured to scan indicia, such as a bar code, on the end of the core section of a media roll loaded onto the media input portion to obtain information on or relating to the media. A retaining portion 315 may be provided to engage the core section of the media roll. The first hub comprises a first retaining portion 315. According to an example, the retaining portion comprises an elastomeric material shaped to engage the core section of the media roll. The rendering apparatus may have a spindle onto which the media roll can be loaded. The first hub is motorised via electrical contacts 340 to enable the media roll to be rotated during the rendering process. For example, the media roll is turned to dispense media for rendering an image on the media.

According to an example, a second hub 320 is provided opposite the first hub at a distal end of the media input portion. The second hub comprises a second retaining portion 325. The second hub may be provided on a slide-able stage 330 that is configured to translate along an elongate part 335 of the media input portion. As such the second hub can slide on the media input portion to adapt to a size or length of the media roll. The side-able stage allows the second hub and second retaining portion to engage the core section of media rolls of different sizes. For example, the core section of a media roll of smaller width can be loaded onto the first retaining portion and the second hub translated into a closer position to the first hub thereby to retain the media roll on the media input portion. As such, a media roll can be loaded into a spindle-less rendering apparatus, i.e. without a spindle.

FIG. 3B shows a schematic of the first hub. FIG. 3C shows an expanded section of the first hub. The first hub 310 comprises a sensor 350 for sensing a media identifier. The first hub comprises a slot or media sensor window 355 through which the sensor can scan the media identifier. The retaining portion 315 is provided with an elastomeric material, such as rubber, to securely engage the core section of a media roll. The retaining portion is fitted to the hub via a spindle. The hub is fitted to the media input portion via a spindle. The hub is motorised 345 to allow the media input portion to rotate the media roll during the rendering process to dispense media.

According to an example, the sensor comprises a photo-detector. As shown in FIG. 3B, the sensor may emit an LED beam through the slotted hub to read or scan a media identifier on a loaded media roll. This allows the rendering apparatus to automatically identify the type of media that is loaded and/or determine the remaining length of media. The photo-detector may be provided under or behind the rotating hubs of the rendering apparatus or located onto a frame of the rendering apparatus.

Identification of the type of media loaded into the rendering apparatus allows the rendering apparatus to set pre-determined print settings for that particular media type. The automatic detection of the media identifier makes redundant the selection of a media type by a user, for example when requesting the user to select from a list in a front panel of the rendering apparatus the type of media which the user has loaded. This reduces the time in which a user spends handling the media and loading the media into the rendering apparatus thereby providing a more efficient use of resources.

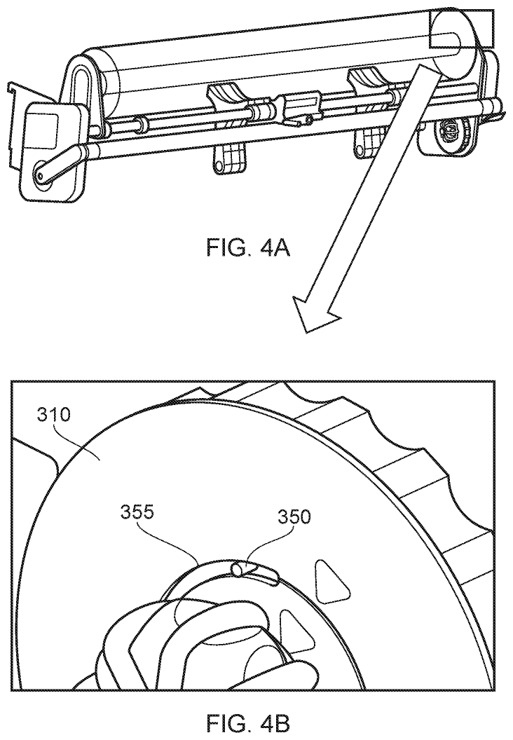

FIGS. 4A and 4B show a schematic of a media roll loaded onto the media input portion. The end of the core section of the media roll is shown adjacent the sensor in the rendering apparatus. Hence, the rendering apparatus can automatically identify properties of the media loaded by the user. This is achieved based on providing slots in a hub holding the end of the media roll and a photosensor to detect the media identifier on the media. For example, the photosensor is used to scan a barcode or serial number on the core of the media roll, where the barcode can hold data on the media's properties, e.g. type of media, length of media, number of rolls or sheets available or remaining.

According to an example, a photodetector is located on the media input system of the rendering apparatus or printer. This detector is able to view the side of the media roll to scan the core section through a slot in the hubs that hold the media roll in place. The photodetector can be fixed to the rendering apparatus such that it scans the side of the core section as the media roll turns.

According to an example, at the moment of loading the media, a rewinder motor spins an entry roll to feed media into the rendering apparatus. The sensor or photo-detector is able to scan the media identifier or code and provide this information to the printer media management firmware. Alternatively, the rendering apparatus may check an online database for characteristics of the media type. This is particularly useful if the media type definition was not available at the moment of the firmware compilation. Once the media is physically loaded and identified by the rendering apparatus the front panel may show a message such as “XXXX media type loaded, with YYYY remaining meters”.

According to an example there is provided a print apparatus comprising a media roll loaded onto a media input portion. The media roll has a media section and a core section, wherein the core section comprises a media identifier located on an end of the core section and disposed annularly about an axis of rotation of the core section. A non-contact sensor is configured to scan the end of the core section in order to sense the media identifier to determine a type of media using the sensed media identifier. The non-contact sensor may comprise a photodetector. The print apparatus may comprise a slotted end portion or hub of the media input portion. The media input portion comprises an opening for the non-contact sensor to scan the end of the core section. This opening may be a slot, or slotted arc, or window of other shape.

According to an example, the rendering apparatus is an ink jet printer.

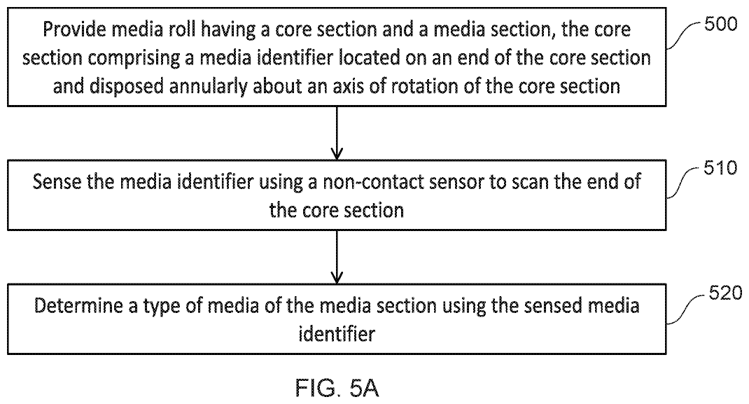

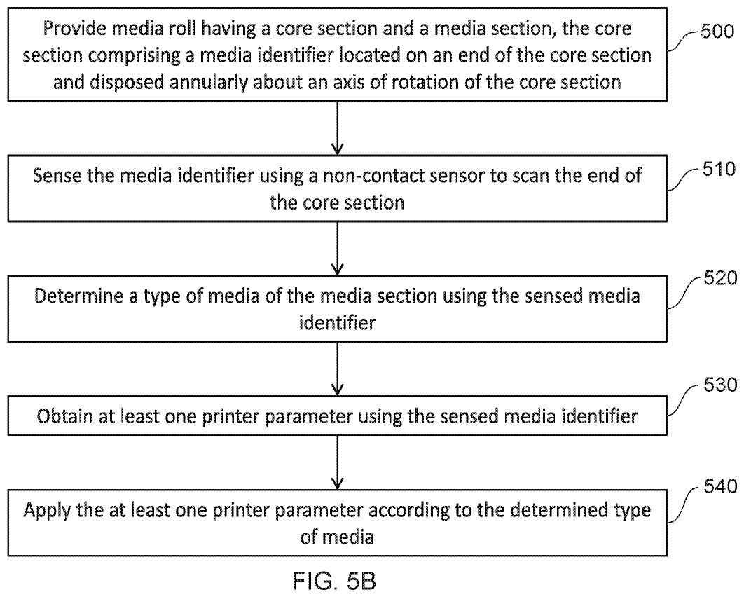

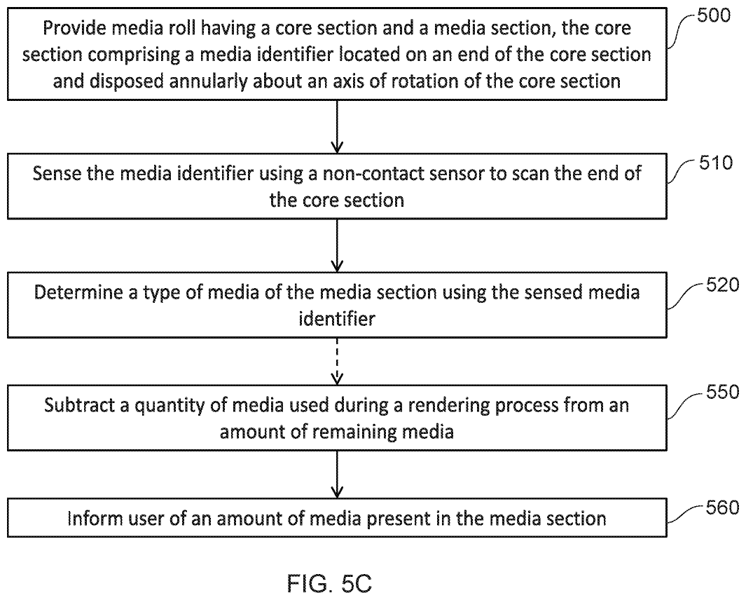

FIGS. 5A-C show a method of determining a type of media in a print apparatus. According to an example, an end user may load a media roll onto a media input portion of a rendering apparatus.

As shown in Figure SA, at block 500 a media roll having a core section and a media section is provided, wherein the core section comprises a media identifier located on an end of the core section and disposed annularly about an axis of rotation of the core section. At block 510 the media identifier is sensed using a non-contact sensor to scan the end of the core section. The sensor may be positioned remote from the core section of the media roll. For example, the sensor may be mounted on a frame or media input portion of the print apparatus. The sensor is provided adjacent the slotted portion of the hub. The sensor can scan the axis of revolution of the end of the core section to detect the media identifier on the media roll. At block 520 a type of media of the media section is determined using the sensed media identifier.

As shown in FIG. 5B, at block 530 at least one printer parameter may be obtained using the sensed media identifier. The sensor or photo-detector transmits the scanned information to a printer media management firmware. According to an example, media settings are pre-installed in the rendering apparatus. For example, the at least one print parameter may comprise one or more of: a color mapping, an ink volume, a vacuum parameter, available print modes, maximum drying temperature, quantity of rendering fluid, and colour profile. According to an example, the firmware may be configured to display a corresponding message on a display panel of media type loaded and/or an indication of the remaining media. As such, adequate media setting may be automatically selected. At block 540 the at least one printer parameter may be applied for the rendering process according to the determined type of media.

As shown in FIG. 5C, an amount of media present in the media section may be determined based on the rendering apparatus recognising the amount of media present when it is new and subtracting a number of media that is used each time an amount of media is dispensed. For example, a code in the core may contain a serial number for a specific media roll and each time that particular roll is loaded and used, the media dispensed is subtracted from the amount of media remaining on the media roll. The user may be informed of the quantity or an estimate of the quantity of remaining media on a media roll.

The configuration described using slots in a hub on the side of a media input portion for the sensor to scan a media identifier on the end of the media roller allows a rendering apparatus, such as a large format printer, to automatically identify which brand, type and size of media is loaded. This makes the process of loading media into a rendering apparatus fast and simple whilst allowing determination of remaining media.

Sensing a media identifier on a core of a media roll instead of sensing a media identifier on the media itself minimizes media waste and improves overall print aesthetics by eliminating unattractive markings on the media. Hence, the amount of scrap media is reduced allowing an improved management of resources.

Providing a media identifier or marks on a core and reading these through a hub enables improved reliability and reduces costs through lower cost components. For example, no electrical connections are provided between the hub and a spindle on which a media roll rotates in rendering apparatus. This reduces costs since lower cost components, such as a photo-detector, can be used and it eliminates rotating electrical contacts on the spindle which are expensive.

By way of comparison, RFID tags have a limited range of detection and may potentially detect other media rolls in the vicinity leading to inaccuracies in media identification. The provision of a photo-detector to scan an end of a core section ensures accurate detection of the relevant media identifier and hence correct media roll.

The method describes may be dynamically applied either to a spindle or spindle-less rendering apparatus.

In some examples, printing of a media identifier on the core section is replaced by permanent indicia, e.g. laser engraved markings, which improve reliability. For example, laser engraved markings provide miniaturisation and more information per unit area for the sensor to detect. This increases reliability and barcode redundancy since printed marks may rub off. Marking the end of a core section replaces markings on an inner core which are difficult to access and apply. Further, this provides better clarity and durability since marks on the inner core are susceptible to damage, marring or detachment when loading/unloading the cores.

The markings on the end of the media roll can provide information on remaining sheets since the markings are fixed relative to each other. The sensor can detect the speed of revolution via the markings where the speed of rotation of the media roll can be known or deduced.

The apparatus and methods described herein allow a faster media load to improve user experience and ensure certified media vendors. Not only is the load process faster, it also avoids human error for the wrong selections of media, which can otherwise lead to poor image quality or even media crashes. As such, it allows the optimum use of the rendering apparatus or printer capabilities whilst preventing image quality issues and media crashes.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

For example, the instructions may be provided on a non-transitory computer readable storage medium encoded with instructions, executable by a processor.

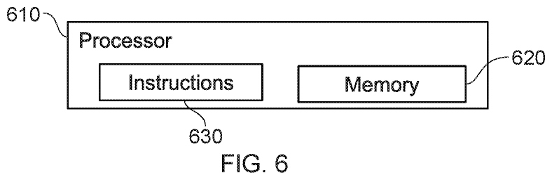

FIG. 6 shows an example of a processor 610 associated with a memory 620. The memory 620 comprises computer readable instructions 630 which are executable by the processor 610. The instructions 630 comprise:

Instructions to sense a media identifier using a non-contact sensor to scan the end of a core section;
Instructions to determine a type of media of the media section using the sensed media identifier;
Instructions to obtain at least one printer parameter using the sensed media identifier;
Instructions to apply the at least one printer parameter according to the determined type of media;
Instructions to sense relative positions of markings within the media identifier within the end of the core section relative to rotation of the core section about an axis of rotation; and
Instructions to determine an amount of media present in the media section.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A print apparatus, comprising:
a media roll loaded onto a media input portion, the media roll having a media section and a core section, the core section comprising a media identifier located on an end of the core section and disposed annularly about an axis of rotation of the core section; and
a non-contact sensor configured to scan the end of the core section in order to sense the media identifier to determine a type of media using the sensed media identifier.

2. A print apparatus according to claim 1, wherein the non-contact sensor comprises a photodetector.

3. A print apparatus according to claim 1, wherein the media input portion comprises an opening for the non-contact sensor to scan the end of the core section.

4. A print apparatus according to claim 1, wherein the print apparatus is an ink jet printer.

5. Method of determining a type of media in a print apparatus, comprising:
providing a media roll having a core section and a media section, the core section comprising a media identifier located on an end of the core section and disposed annularly about an axis of rotation of the core section;
sensing the media identifier using a non-contact sensor to scan the end of the core section; and
determining a type of media of the media section using the sensed media identifier.

6. A method according to claim 5, further comprising sensing the media identifier on the end of the core section through a slotted end portion of a media input portion.

7. A method according to claim 5, further comprising the sensor being positioned remote from the core section to scan an axis of revolution of the end of the core.

8. A method according to claim 5, further comprising obtaining at least one printer parameter using the sensed media identifier.

9. A method according to claim 8, further comprising applying the at least one printer parameter according to the determined type of media.

10. A method according to claim 8, wherein the at least one print parameter comprises a color mapping or ink volume.

11. A method according to claim 5, further comprising determining an amount of media present in the media section based on subtracting a quantity of media used during a rendering process from an amount of media remaining.

12. A method according to claim 5, further comprising a user loading the media roll onto a media input portion.

13. A media roll for a print apparatus, comprising:
a media section; and
a core section, the core section comprising a media identifier located on an end of the core section and disposed annularly about an axis of rotation of the core section.

14. A media roll according to claim 13, wherein the media identifier comprises one or more of: grooves; notches; slots; and embossments.

15. A media roll according to claim 13, wherein the media identifier comprises a series of lines or engravings arranged in a pattern of marks and non-marks to be interpreted as a code.
